(19) United States
(12) Patent Application Publication
(10) Pub. No.: US 2022/0013881 A1
(43) Pub. Date: Jan. 13, 2022

(54) INSULATING GLAZING UNIT AND GLAZING

(71) Applicant: SAINT-GOBAIN GLASS FRANCE, COURBEVOIE (FR)

(72) Inventors: Alicia DRÖGE, HERZOGENRATH (DE); Thomas HOLTSTIEGE, SCHWELM (DE); Christopher MARJAN, AACHEN (DE); Christian EFFERTZ, AACHEN (DE)

(21) Appl. No.: 17/296,778

(22) PCT Filed: Jan. 21, 2020
(86) PCT No.: PCT/EP2020/051339

§ 371 Date: May 25, 2021

(30) Foreign Application Priority Data
Jan. 29, 2019 (EP) 19154159.8

(51) Int. Cl. H01Q 1/12; E06B 3/663; E06B 3/673; H04B 1/59; H01Q 9/16

(52) U.S. Cl. CPC H01Q 1/1271; E06B 3/66309; E06B 3/12; H04B 1/59; H01Q 9/16; E06B 3/6733

(57) ABSTRACT

An insulating glazing unit includes a spacer which is shaped around the periphery to form a spacer frame and delimits an inner region, a first glass pane, which is arranged on a pane contact surface of the spacer frame, and a second glass pane, which is arranged on a second pane contact surface of the spacer frame, and the glass panes project beyond the spacer frame and form an outer region, which is filled, at least in sections with a sealing element, wherein an RFID transponder is arranged in the outer region or in the outer edge region of the glass panes, and a strip-shaped coupling element is electromagnetically coupled to the RFID transponder.

The invention relates to an insulating glazing unit that has at least two glass panes and a spacer and sealing profile extending circumferentially therebetween close to their edges, wherein at least one RFID transponder is attached to the insulating glazing unit as an identification element. The invention further relates to a glazing with a metal frame and an insulating glazing unit inserted in the frame, wherein the frame engages around the edges of the insulating glazing unit and, at the same time, covers the RFID transponder(s). The glazing is intended, in particular, to form a façade glazing, a window, a door, or an interior partition with a corresponding structure.

Modern windows, doors, and façade glazings, at least for use in northern and temperate latitudes, are usually produced using prefabricated insulating glazing units (IGUs) that have the aforementioned structure, but, optionally, can include even more than two glass panes in the combination. Such insulating glazing units are mass-produced, shipped, and also independently marketed products that should be uniquely identifiable on their way to an end product and possibly even during maintenance and servicing.

It is already known to provide insulating glazing units with identifying markings, and certain requirements of manufacturers and users have arisen in the related practice:
The identifying marking should not be visible either from the inside or from the outside of the finished window, door, or façade.
The marking should be “readable” from a distance of at least 30 cm.
The marking should be as forgery-proof as possible, i.e., should not be readily possible to overwrite or to copy.

The effectiveness of conventional identifying markings, such as barcodes or QR codes, is based on their visibility, which means at least one restriction under the first aspect above. Meeting the second requirement is also difficult. Protection against copying cannot be guaranteed since barcodes and QR codes can be photographed.

It has also been proposed to provide insulating glazing units with “electronic” identifiers, in particular via radio readable identifiers, so-called “RFID transponders”. Such insulating glazing units are, for example, disclosed in WO 00/36261 A1 or WO 2007/137719 A1. Furthermore, RFID transponders for marking solid and composite material panels are known from EP 2 230 626 A1.

Such an RFID transponder can be protected with a password such that it cannot be overwritten or its radio capability destroyed without considerable effort.

Certain types of window and door frames, but especially façade constructions in which insulating glazing units are installed are made completely or at least partially of a metal (aluminum, steel . . . ), which interrupts or at least greatly attenuates the passage of radio waves from or to the RFID transponder on the insulating glazing unit. For this reason, meeting the second requirement above has, in particular, proved difficult. Known insulating glazing units provided with RFID transponders are, consequently, not readily usable with metal frame constructions. This reduces the potential range of application of glazing units identified in this manner and thus the acceptance of these marking solutions by manufacturers and users.

The object of the invention is, consequently, to provide an improved insulating glazing unit for glazings with frame constructions that are made at least to a considerable extent of a metal and that also ensures meeting the aforementioned requirements in such installation situations.

This object is accomplished according to a first aspect of the invention by an insulating glazing unit with the features of claim 1. According to the further aspect of the invention, it is accomplished by a glazing with an insulating glazing unit according to the invention. Expedient further developments of the idea of the invention are the subject matter of the respective dependent claims.

The invention comprises an insulating glazing unit, comprising:
at least one spacer, which is shaped around the periphery to form a spacer frame and delimits an inner region,
a first glass pane, which is arranged on a pane contact surface of the spacer frame, and a second glass pane, which is arranged on a second pane contact surface of the spacerframe, and
the glass panes project beyond the spacer frame and form an outer region, which is filled, at least in sections, preferably completely, with a sealing element,

wherein
at least one RFID transponder is arranged in the outer region or in the outer edge region of the glass panes, and
a strip-shaped coupling element is electromagnetically coupled to the RFID transponder.

Advantageously, the RFID transponder has a dipole antenna and the coupling element is electromagnetically coupled to one antenna pole of the dipole antenna of the RFID transponder.

Here, the term “electromagnetically coupled” means that the coupling element and the RFID transponder are coupled by an electromagnetic field, i.e., are connected both capacitively and inductively and preferably not galvanically.

According to the invention, at least one RFID transponder is arranged in the outer region (between the glass panes and around the spacer frame) or in the outer edge region of the glass panes.

In the context of the present invention, the outer edge region of the glass panes is formed by the end faces of the glass panes and by a region of the outer surfaces of the glass panes that is near the end faces.

In the context of the present invention, the term “outer surface” of the glass pane refers to the respective surface of the glass pane facing away from the spacer frame and the term “inner surface” of the glass pane refers to the surface of the glass pane facing the spacer frame.

A further aspect of the invention comprises a glazing, in particular a façade glazing, a window, a door, or an interior partition, comprising:
a frame consisting of a metal first frame element, a metal second frame element, and a polymeric third frame element connecting the frame elements at least in sections and preferably completely circumferentially, and
an insulating glazing unit according to the invention arranged in the frame, wherein the coupling element is galvanically or capacitively coupled in at least one coupling region with one of the metal frame elements and preferably in two coupling regions with one of the metal frame elements in each case.

The frame engages, preferably in the shape of a U, around the end face of the insulating glazing unit and, at the same time, covers the RFID transponder(s) in the through-vision direction through the glass panes. Usually, the legs of the first and second frame elements are designed such that they at least completely cover the outer region and the spacer frame in the through-vision direction through the insulating glazing unit.

The invention includes the idea of taking into account the fundamentally unfavorable outgoing and incoming radiation conditions for radio waves in a metal frame of a glazing by means of special coupling in and coupling out of the RFID signal. It further includes the idea of arranging a coupling element that is provided separately from the RFID transponder on the insulating glazing unit such that with suitable installation in a glazing, it couples optimally with its frame and effects signal transfer from the frame to the antenna of the RFID transponder or from the antenna of the RFID transponder to the frame and thus to the outside of the glazing unit.

The invention is a result of extensive experimental investigations undertaken on insulating glazing units and glazings with the aforementioned basic structure.

Advantageous spacers consist of a desiccant-filled hollow profile that is made of metal or is coated, at least in sections, with a metal foil or metallized foil, and in which a sealing element (likewise circumferential) is applied on the pane outer surface of the spacer (hereinafter “outer surface of the spacer”).

With regard to the application situation, the inventors carried out, in particular, investigations on insulating glazing units embedded in metallic frames, wherein the frame consists of two metal and thus electrically conductive frame elements that are connected via a polymeric and electrically insulating frame element. Such frames made of two metal frame elements that are connected by a polymeric frame element are particularly advantageous since the polymeric frame element significantly reduces heat transfer from the first frame element to the second frame element and, thus, for example, from an exterior-space side to an interior-space side.

Elastomer profiles that seal the glazing and fix the glass panes are arranged between the outer sides of the glass panes and the inner sides of the adjacent metal frame elements.

Commercially available UHF-RFID transponders, whose structure and functionality are well known and, consequently, need not be further described here, were used in the investigations.

In an advantageous embodiment of an insulating glazing unit according to the invention, the RFID transponder is implemented as a dipole antenna. Such designs can be arranged particularly well in the elongated and strip-shaped outer region along the spacer and between the glass panes, on the end faces of the glass panes, or on the outer surfaces of the glass panes within the frame.

The dipole antenna includes or consists of at least one first antenna pole and one second antenna pole. Preferably, the antenna poles are arranged in a line one behind the other and thus parallel to one another. RFID electronics or a connection to RFID electronics is usually arranged in the center, between the antenna poles.

The coupling element according to the invention is arranged in sections congruently over the RFID transponder. In this context, “in sections congruently” means that the coupling element covers the dipole antenna in sections, in the orthogonal projection onto the RFID transponder.

If the RFID transponder is arranged, for example, within the outer region that is formed by the projection of the glass panes beyond the spacerframe, the coupling element covers the RFID transponder and, in particular, one antenna pole of the dipole antenna of the RFID transponder, in sections in the viewing direction perpendicular to the end face of the insulating glazing. It goes without saying that for optimal capacitive coupling of the coupling element to the RFID transponder and forwarding the RFID radio signal according to the invention, the coupling element is at least similar in size to the dipole antenna of the RFID transponder. In particular, the coupling element projects beyond the dipole antenna in the projection both on one side along the direction of the dipole antenna and also transversely to the direction of extension. Here, the direction of extension of the dipole antenna is the longitudinal direction of the dipole antenna, i.e., along its antenna poles arranged linearly relative to one another and in the direction of its straight extension.

The radio wavelengths used in such RFID transponder systems are usually, depending on type, in the range of UHF at 865-869 MHz (including European frequencies) or 902-928 MHz (US and other frequency bands) or the SHF at 2.45 GHz and 5.8 GHz. The frequencies released for UHF-RFID transponders differ regionally for Asia, Europe, and America and are coordinated by the ITU.

Radio signals with these frequencies penetrate both wood and conventional plastics, but not metals. In particular, when the dipole antenna is placed directly on a metal spacer or on a metal foil or on a metallized foil on the spacer, this can lead to a short-circuit of the dipole antenna and thus to undesirable impairment of the RFID transponder.

Consequently, in a preferred embodiment of the RFID transponder, the dipole antenna is arranged on a dielectric carrier element, particularly preferably a polymeric carrier element. The thickness of the carrier element is adapted to the material and, in particular, to the dielectric constant of the carrier element and to the geometry of the dipole.

It goes without saying that the dipole antennas together with electronics per se can be arranged on a dielectric and, for example, polymeric carrier layer, significantly simplifying assembly and prefabrication.

The findings of the inventors apply in principle to both passive and active RFID transponders.

With regard to the metal frame that engages around the insulating glazing unit and that, based on elementary laws of physics and according to the knowledge of the person skilled in the art based thereon, should sensitively interfere with, if not completely suppress, the HF radiation of RFID transponders placed near the edge or their antennas, the proposed solution is surprising. It yields the unforeseen advantage that an RFID transponder placed according to the invention can still be read out without problems and reliably at a relatively great distance of approx. 2 m from the glazing, in which the insulating glazing unit according to the invention is installed.

It goes without saying that, by simple experiments, the person skilled in the art can find designs and positions with advantageous transmission and reception properties. The exemplary embodiments and aspects mentioned in the following are consequently primarily recommendations for the person skilled in the art, without restricting the implementation possibilities of the invention.

it goes without saying that an insulating glazing unit can have a plurality of RFID transponders, in particular in the edge or outer regions of the various sides (top, bottom, right, left) of the insulating glazing. This is usually necessary with prior art insulating glazings with only short ranges of the RFID transponders in order to quickly find an RFID signal and quickly identify the insulating glazing unit. As a result of the increase in the range of the RFID transponder according to the invention, exactly one or few RFID transponders per insulating glazing usually suffice.

In an advantageous embodiment of the insulating glazing unit according to the invention, the coupling element includes or consists of a self-supporting metal foil, preferably made of aluminum, an aluminum alloy, copper, silver, or stainless steel. Preferred metal foils have a thickness of 0.02 mm to 0.5 mm and in particular of 0.09 mm to 0.3 mm. Such coupling elements can be readily integrated into the insulating glazing unit and are, moreover, simple and economical to manufacture.

It goes without saying that the metal foil can also be stabilized by a polymer film or can be electrically insulated on one or both sides.

In an alternative advantageous embodiment of the insulating glazing unit according to the invention, the coupling element includes or consists of a metallized polymer film with a preferred metallization of aluminum, an aluminum alloy, copper, silver, or stainless steel. Preferred metal layers have a thickness of 10 μm to 200 μm. Such coupling elements can also be readily integrated into the insulating glazing unit and are, moreover, simple and economical to produce.

The coupling element according to the invention is arranged, at least in sections, on the end face of the insulating glazing unit. In this case, it can preferably be arranged on a section of an end face of one of the glass panes and on the outer side of the outer region. Alternatively, the coupling element can also be arranged in sections within the outer region and, in particular, extend into the sealing element.

Alternatively, the coupling element can also be arranged on the two end faces of the glass panes and on the intervening outer side of the outer region or within the outer region.

The coupling element projects beyond at least one of the glass panes, preferably both glass panes, transversely to the direction of extension of the glass pane. Here, the “direction of extension” of the glass pane means the direction of the long side of the glass pane as opposed to the short side of the glass pane, formed merely by the material thickness of the glass pane.

In an advantageous embodiment of an insulating glazing unit according to the invention, the coupling element projects beyond the first glass pane and/or the second glass pane by an overhang U, which depends on the distance of the glass pane from the metal frame element. The distance of the glass pane from the metal frame element depends in particular on the thickness of the elastomer profile, which is, for example, 6 mm to 7 mm.

The overhang U is preferably from 2 mm to 30 mm, particularly preferably from 5 mm to 15 mm, and in particular from 7 mm to 10 mm.

In another advantageous embodiment of an insulating glazing unit according to the invention, the RFID transponder is arranged, preferably directly, on the outer side of the spacer and, in particular, adhered thereon. In an alternative advantageous embodiment of an insulating glazing unit according to the invention, the RFID transponder is arranged, preferably directly, on one of the glass panes and, in particular, adhered thereon. It goes without saying that the RFID transponder can also be arranged within the material of the sealing element, for example, by insertion into the still liquid sealing element and subsequent curing or solidification.

In another advantageous embodiment of an insulating glazing unit according to the invention, the distance A between the dipole antenna of the RFID transponder and the coupling element is from 0 mm to 10 mm, preferably from 0 mm to 4 mm, particularly preferably from 1 mm to 4 mm.

The preferred length L of the coupling element, i.e., the length parallel to the direction of extension of the dipole antenna, depends on the operating frequency of the RFID transponder.

In another advantageous embodiment of an insulating glazing unit according to the invention, the coupling element has a length L parallel to the dipole antenna greater than or equal to 40% of the half wavelength lambda/2 of the operating frequency of the dipole antenna, preferably from 40% to 240%, particularly preferably from 60% to 120%, and in particular from 70% to 95%.

For RFID transponders in the UHF range, in particular for RFID transponders at 865-869 MHz (including European frequencies) or 902-928 MHz (US and other frequency bands), particularly good results were obtained for coupling elements with a length L of more than 7 cm, preferably of more than 10 cm, and in particular of more than 14 cm. The maximum length was less critical. For example, maximum lengths of 30 cm stilled to good results and good reading ranges.

In an alternative advantageous embodiment of an insulating glazing unit according to the invention, the coupling element has a length L parallel to the dipole antenna from 7 cm to 40 cm, preferably from 10 cm to 20 cm, and in particular from 12 cm to 16 cm.

In an advantageous embodiment of an insulating glazing unit according to the invention, the coupling element covers only one antenna pole of the dipole antenna and projects beyond the antenna pole on the side facing away from the other antenna pole. Here, “to cover” means that the coupling element is arranged in front of the respective antenna pole in the viewing direction toward the RFID transponder and covers it. Or, in other words, the coupling element covers the respective antenna pole in the orthogonal projection.

For example, the coupling element covers only the first antenna pole of the dipole antenna and extends beyond the first antenna pole on the side facing away from the second antenna pole. Alternatively, the coupling element covers only the second antenna pole of the dipole antenna and extends beyond the second antenna pole on the side facing away from the first antenna pole.

Advantageously, one edge of the coupling element is arranged above the center of the dipole antenna and extends over the first or the second antenna pole. As investigations by the inventors revealed, the coupling element can also have a small offset V between the edge of the coupling element and the center of the dipole antenna, wherein the offset V is measured in the projection of the coupling element onto the dipole antenna. The offset V thus means that the projection of the edge of the coupling element is not arranged exactly in the center between the antenna poles of the dipole antenna, but, instead, deviates by an offset V therefrom in the direction of extension of one antenna pole or in the direction of extension of the other antenna pole.

The respective maximum offset depends on the half wavelength lambda/2 of the operating frequency of the dipole antenna.

An offset of V=0 is optimal. However, good results and reading ranges were still achieved for deviations from this. Advantageously, the offset V is from −20% to +20% of the half wavelength lambda/2 of the operating frequency of the RFID transponder, preferably from −10% mm to +10% and in particular from −5% to +5%.

In another advantageous embodiment of the invention, the offset V at an operating frequency of the RFID transponder in the UHF range is from −30 mm to +30 mm, preferably from −20 mm to +20 mm, and in particular from −10 mm to +10 mm. Here, a positive sign means, for example, that the edge of the coupling element is arranged in the projection on the second antenna pole and the remainder of the second antenna pole is completely covered; whereas, in contrast, the first antenna pole is completely uncovered. Conversely, a negative sign means that the edge of the coupling element is arranged in the projection on the first antenna pole, and a section of the first antenna pole as well as the remainder of the second antenna pole is completely covered.

The width of the coupling element depends on the width of the end face of the insulating glazing unit and the respective one-sided or two-sided overhang beyond the glass panes. Typical widths are from 2 cm to 10 cm and preferably from 3 cm to 5 cm.

The specific dimensioning will be carried out by the person skilled in the art under consideration of the dimensions of the insulating glazing unit, on the one hand, and of the surrounding frame, on the other, in particular taking into account the width of the frame.

The coupling element according to the invention is galvanically or capacitively coupled in at least one coupling region with one of the metal frame elements and preferably in two coupling regions with one of the metal frame elements in each case. The coupling element is preferably in direct contact with the metal frame element and is galvanically connected therewith, for example. Preferably, the coupling element contacts the metal frame element over its entire length.

The coupling element does not have to be fixedly anchored to the metal frame element. Instead, even loose contact or clamping is sufficient. In particular, capacitive coupling between the coupling element and the metal frame element in the coupling region suffices.

There are various options for the placement of the RFID transponder in the insulating glazing unit from which the person skilled in the art can select a suitable one, taking into account the specific mounting technology of the IGU and also with respect to the specific façade or window construction. In certain embodiments, the RFID transponder, to which a coupling element is assigned, is placed on the outer surface of the spacer profile. In an alternative embodiment, the RFID transponder, to which a coupling element is assigned, is placed on a outer-region surface of one of the glass panes at or near its boundary edge.

In an advantageous embodiment of an insulating glazing unit according to the invention, the RFID transponder is arranged in the outer region formed by the projection of the glass panes beyond the spacer frame. The RFID transponder is particularly preferably arranged directly on the outer surface of the spacer or on the inner surface of one of the glass panes. Alternatively, the RFID transponder can be arranged in the middle of the outer region, i.e., without direct contact with the outer surface of the spacer and without direct contact with the inner surfaces of the glass panes.

In another advantageous embodiment of an insulating glazing unit according to the invention, the RFID transponder is arranged on an outer surface of one of the glass panes at a distance of at most 10 mm, preferably at most 50 mm, and particularly preferably of at most 3 mm from the adjacent end face of the respective glass pane. Alternatively, an RFID transponder is arranged on an end face of one of the glass panes.

It goes without saying that a plurality of RFID transponders can also be arranged at various ones of the aforementioned positions.

In an advantageous embodiment of an insulating glazing unit according to the invention, the strip-shaped coupling element is arranged
within the sealing element in the outer region,
on an outer side of the outer region,
on at least one end face of the glass panes, and/or
[on] an outer side of the glass panes.

Advantages and functionalities of the invention are also evident from the following description of exemplary embodiments and aspects of the invention with reference to the figures. The drawings are purely schematic representations and not to scale. They in no way restrict the invention. They depict:

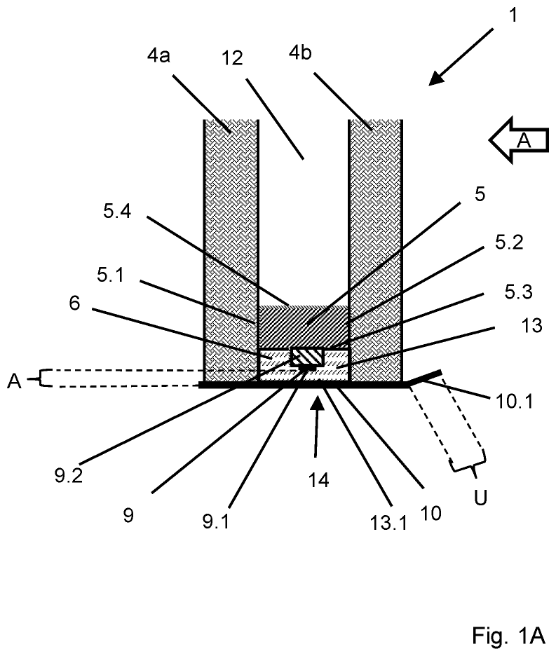

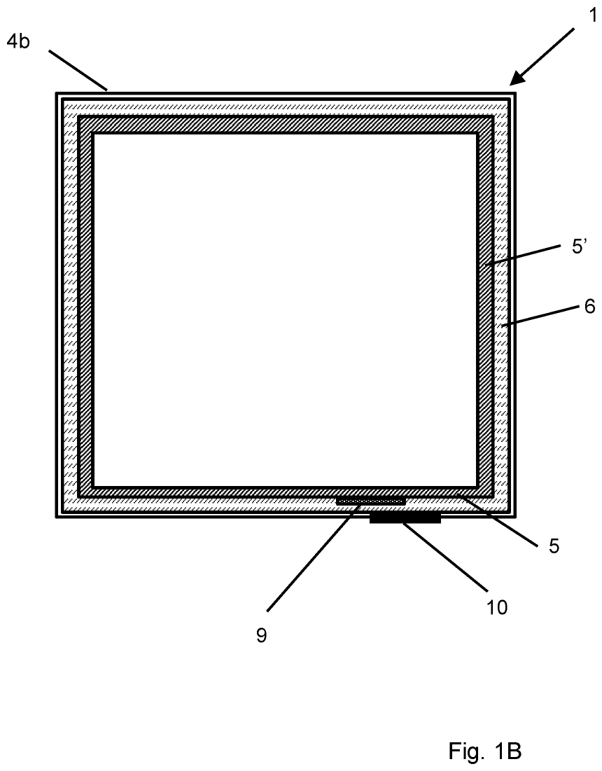

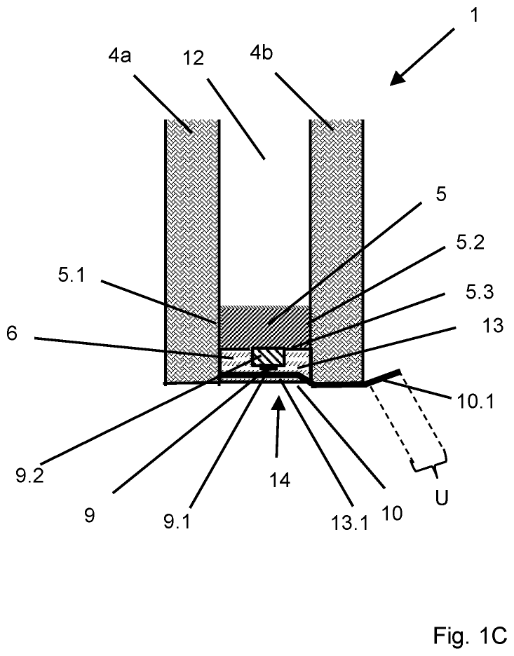

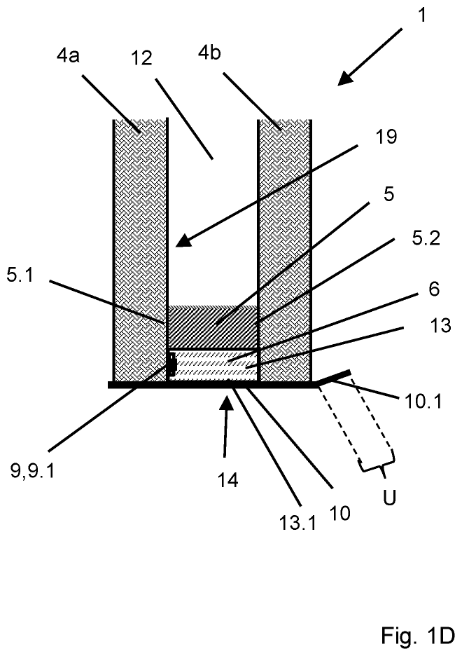

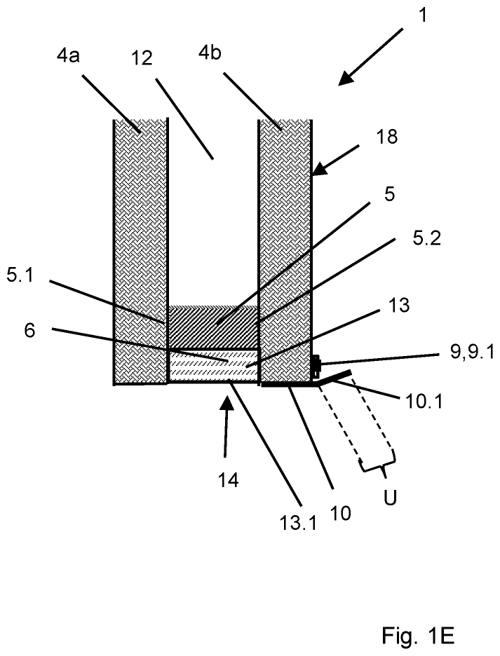

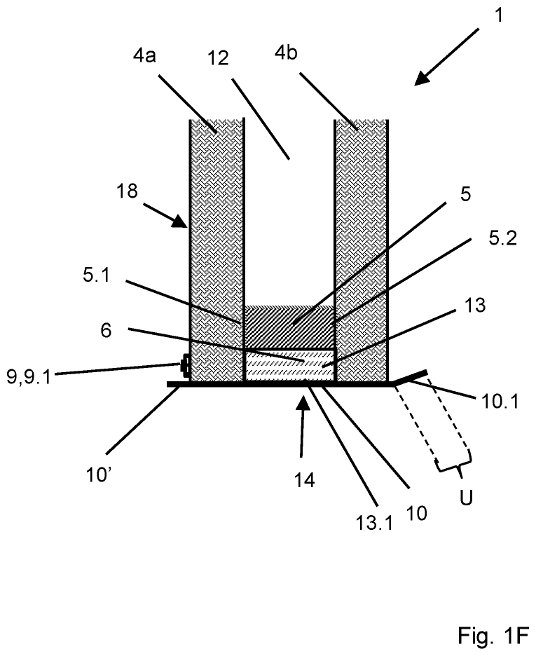

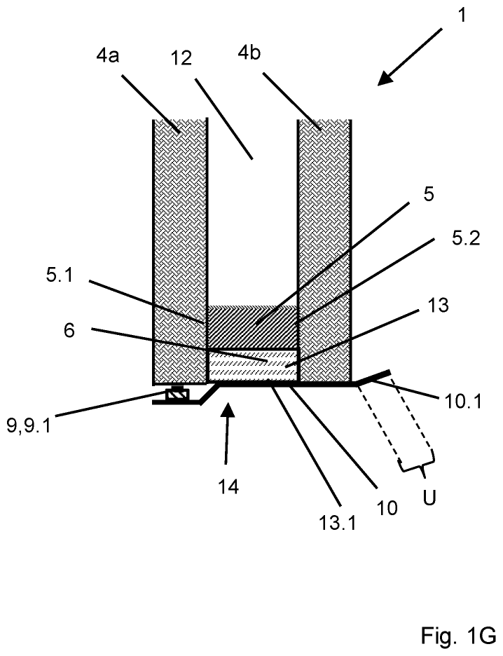

FIG. 1A a detailed view (cross-sectional representation) of an edge region of an insulating glazing unit in accordance with an embodiment of the invention,

FIG. 1B a plan view of an insulating glazing unit in accordance with the embodiment of the invention of FIG. 1A,

FIG. 10 a detailed view (cross-sectional representation) of an edge region of an insulating glazing unit in accordance with another embodiment of the invention,

FIG. 1D a detailed view (cross-sectional representation) of an edge region of an insulating glazing unit in accordance with another embodiment of the invention,

FIG. 1E a detailed view (cross-sectional representation) of an edge region of an insulating glazing unit in accordance with another embodiment of the invention,

FIG. 1F a detailed view (cross-sectional representation) of an edge region of an insulating glazing unit in accordance with another embodiment of the invention,

FIG. 1G a detailed view (cross-sectional representation) of an edge region of an insulating glazing unit in accordance with another embodiment of

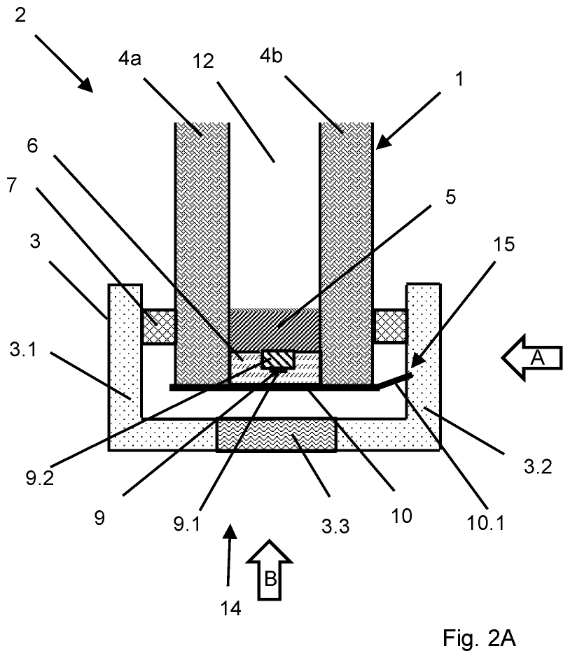

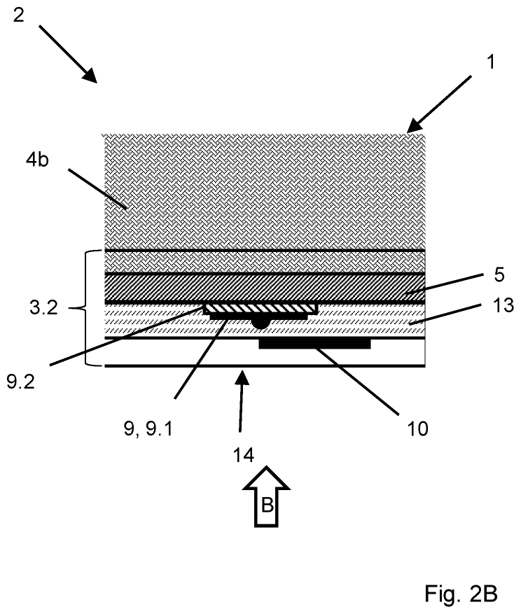

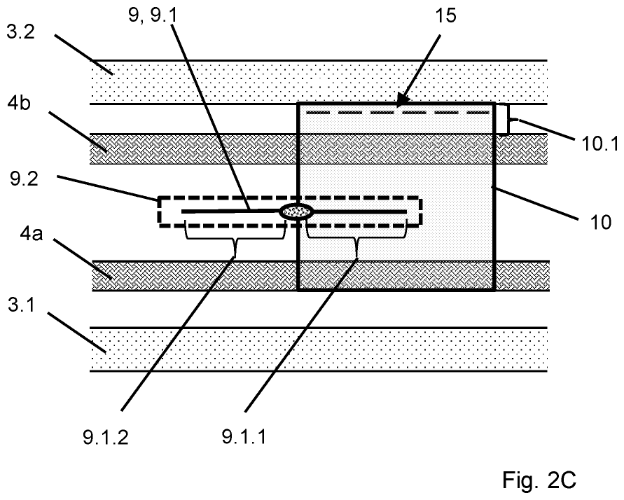

FIG. 2A a detailed view (cross-sectional representation) of an edge region of a glazing with an insulating glazing unit in accordance with an embodiment of the invention,

FIG. 2B a detailed view (plan view) of a detail of the glazing with an insulating glazing unit of FIG. 2A,

FIG. 2C a detailed view (cross-sectional representation) of the glazing in a section plane parallel to the end face of the insulating glazing unit of FIG. 2A,

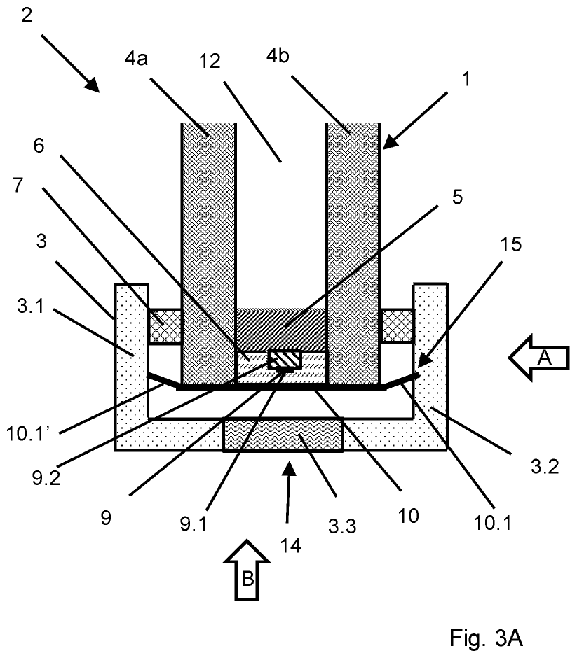

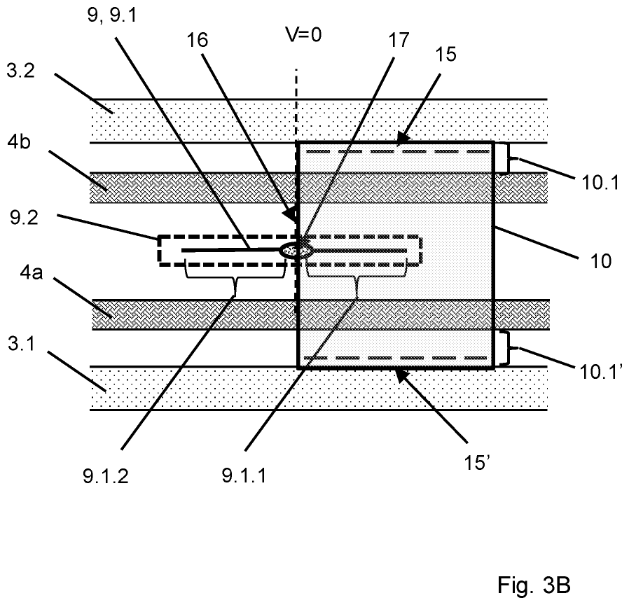

FIG. 3A a detailed view (cross-sectional representation) of an edge region of a glazing with an insulating glazing unit in accordance with another embodiment of the invention,

FIG. 3B a detailed view (cross-sectional representation) of the glazing in a section plane parallel to the end face of the insulating glazing unit of FIG. 3A, and

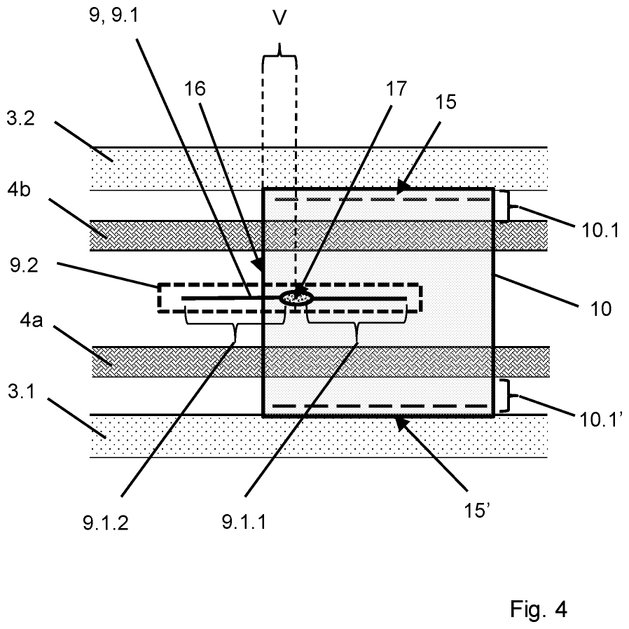

FIG. 4 a detailed view (cross-sectional representation) of a glazing in a section plane parallel to the end face of the insulating glazing unit in accordance with another embodiment.

In the figures as well as the following description, the insulating glazing units as well as the glazings and the individual components are in each case identified with the same or similar reference numbers regardless of the fact that the specific embodiments differ.

FIG. 1A depicts an edge region of an insulating glazing unit 1, in cross-section. The insulating glazing unit 1 comprises, in this embodiment, two glass panes 4a and 4b. These are held at a predetermined distance by a spacer 5 placed between the glass panes 4a, 4b near the end face 14 of the insulating glazing unit 1. The main body of the spacer 5 is made, for example, of glass-fiber-reinforced styrene acrylonitrile (SAN).

FIG. 1B depicts a schematic plan view of the insulating glazing unit 1 in a viewing direction indicated by the arrow A. FIG. 1B therefore depicts the second glass pane 4b lying on top.

Multiple spacers 5 (here, for example, four) are routed along the side edges of the glass panes 4a, 4b and form a spacer frame 5′. The pane contact surfaces 5.1, 5.2 of the spacers 5, i.e., the contact surfaces of the spacers 5 to the glass panes 4a, 4b, are bonded in each case to the glass panes 4a or 4b and thus mechanically fixed and sealed. The adhesive bond is made, for example, of polyisobutylene or butyl rubber. The inner surface 5.4 of the spacer frame 5′ delimits, together with the glass panes 4a, 4b, an inner region 12.

The spacer 5 is usually hollow (not shown) and filled with a desiccant (not shown), which binds, via small interior-side openings (likewise not shown), any moisture that has penetrated into the inner region 12. The desiccant contains, for example, molecular sieves such as natural and/or synthetic zeolites. The inner region 12 between the glass panes 4a and 4b is filled, for example, with a noble gas, such as argon.

The glass panes 4a, 4b usually project beyond the spacer frame 5′ on all sides such that the outer surface 5.3 of the spacer 5 and the outer sections of the glass panes 4a, 4b form an outer region 13. A sealing element (sealing profile) 6 is introduced into this outer region 13 of the insulating glazing unit 1 between the glass panes 4a and 4b and outside the spacer 5. This is shown here in simplified form as a single piece. In practice, it usually comprises two components, one of which seals the contact surface between the spacer 5 and the glass panes 4a, 4b and protects against penetrating moisture and external influences. The second component of the sealing element 6 additionally seals and mechanically stabilizes the insulating glazing unit 1. The sealing element 6 is, for example, formed from an organic polysulfide.

An insulation film (not shown here), which reduces the heat transfer through the polymeric spacer 5 into the inner region 12, is applied, for example, on the outer surface 5.3 of the spacer 5, i.e., on the side of the spacer 5 facing the outer region 13. The insulation film can, for example, be attached to the polymeric spacer 5 with a polyurethane hot-melt adhesive. The insulation film includes, for example, three polymeric layers of polyethylene terephthalate with a thickness of 12 μm and three metal layers made of aluminum with a thickness of 50 nm. The metal layers and the polymeric layers are attached alternatingly in each case, with the two outer plies formed by polymeric layers. In other words, the layer sequence consists of a polymeric layer, followed by a metal layer, followed by an adhesive layer, followed by a polymeric layer, followed by a metal layer, followed by an adhesive layer, followed by a metal layer, followed by a polymeric layer.

As already mentioned, the main body of the spacer 5 is made, for example, of glass-fiber-reinforced styrene acrylonitrile (SAN). By means of the selection of the glass fiber content in the spacer main body, its coefficient of thermal expansion can be varied and adjusted. By adjusting the coefficient of thermal expansion of the spacer main body and of the insulation film, temperature-induced stresses between the different materials and flaking of the insulation film can be avoided. The spacer main body has, for example, a glass fiber content of 35%. The glass fiber content in the spacer main body simultaneously improves strength and stability.

The first glass pane 4a and the second glass pane 4b are made, for example, of soda lime glass with a thickness of 3 mm and have, for example, dimensions of 1000 mm×1200 mm. It goes without saying that each insulating glazing unit 1 depicted in this and the following exemplary embodiments can also have three or more glass panes.

The insulating glazing unit 1 of FIGS. 1A and 1B is provided, by way of example, with an RFID transponder 9, which is arranged within the seal 6 and, here, for example, directly on the outer surface 5.4 of the spacer 5. It goes without saying that the RFID transponder 9 can also be arranged on the glass panes 4a or 4b within the outer region 13. The RFID transponder 9 is, for example, glued on the spacer 5 or fixed by the seal 6.

The operating frequency of the RFID transponder is in the UHF range and, for example, 866.6 MHz.

In the example shown, this is an RFID transponder 9, in which the dipole antenna 9.1 is arranged on a dielectric carrier body 9.2. This is necessary, since the spacer 5 has, as mentioned above, a metallized and, thus, electrically conductive (thermal) insulation film. Without the dielectric carrier body 9.2, the dipole antenna 9.1 would be arranged directly on the electrically conductive insulation film and thus “short-circuited”. Through the use of an RFID transponder 9 with a dielectric carrier body 9.2 (a so-called “on-metal” RFID transponder), the short-circuit can be avoided.

It goes without saying that in the case of spacers 5 made of a dielectric without insulation film or with purely dielectric insulation films (e.g., without metallization), the dipole antenna 9.1 of the RFID transponder 9 need not have a dielectric carrier body 9.2.

Furthermore, arranged on the end face 14 of the insulating glazing unit 1 is a coupling element 10, consisting, for example, of a 0.1-mm-thick copper foil. Here, the coupling element 10 extends, for example, from the end face 14 of the first glass pane 4a over the sealing element 6 and over the end face of the second glass pane 4b and has, on one side, an overhang 10.1 beyond the second glass pane 4b. The overhang U is, for example, 9 mm.

One edge of the coupling element 10 is arranged roughly congruently over one of the two antenna poles of the dipole antenna 9.1. In other words, the edge of the coupling element 10 is arranged essentially in the center of the dipole antenna 9.1.

Here, “congruently arranged” means that the coupling element 10 is arranged within the orthogonal projection of the antenna pole of the dipole antenna 9.1 with respect to the end face 14 of the insulating glazing unit 1, in the outer region 13 of which the RFID transponder 9 is arranged and at least completely covers it. In other words, the coupling element 10 is arranged, with respect to a plan view of the end face 14 of the insulating glazing unit 1, in front of the RFID transponder 9 and completely covers one antenna pole of the dipole antenna 9.1.

The length L of the coupling element 10 in its direction of extension parallel to the direction of extension of the dipole antenna 9.1 and thus parallel to the direction of extension of the long side of the glass panes 4a, 4b, is, for example, 15 cm. Thus, the coupling element 10 is roughly as long as the dipole antenna 9.1 and thus projects on one side beyond its end by approx. 50%.

Due to the small distance distance A of, for example, 2 mm between the dipole antenna 9.1 of the RFID transponder 9 and the coupling element 10 and the electrical insulation positioned therebetween by the sealing element 6, an electromagnetic coupling according to the invention takes place between the dipole antenna 9.1 and the coupling element 10.

FIG. 10 depicts a detailed view (cross-sectional representation) of an edge region of an insulating glazing unit 1 in accordance with another embodiment of the invention. The insulating glazing unit 1 of FIG. 10 differs from the insulating glazing unit 1 of FIG. 1A only in that the coupling element 10 is arranged in sections within the outer region 13 and within the sealing compound 6.

FIG. 1D depicts a detailed view (cross-sectional representation) of an edge region of an insulating glazing unit 1 in accordance with another embodiment of the invention. The insulating glazing unit 1 of FIG. 1D differs from the insulating glazing unit 1 of FIG. 1A only in the position of the RFID transponder 9, which, here, is arranged on an inner surface 19 of the first glass pane 4a lying in the outer region 13. Since, here, the RFID transponder 9 is arranged on a glass pane, i.e., an electrically insulating substrate, it does not necessarily have to have a dielectric carrier element 9.2. The RFID transponder 9 can be arranged on the glass pane 4a directly or only separated by a thin carrier film and/or an adhesive film. It goes without saying that the RFID transponder 9 can also have a dielectric carrier element 9.2 in this exemplary embodiment, without affecting the mode of operation.

FIG. 1E depicts a detailed view (cross-sectional representation) of an edge region of an insulating glazing unit 1 in accordance with another embodiment of the invention. The insulating glazing unit 1 of FIG. 1E differs from the insulating glazing unit 1 of FIG. 1A only in the position of the RFID transponder 9, which, here, is arranged on the outer surface 18 of the second glass pane 4b. Since, here, the RFID transponder 9 is arranged on a glass pane, i.e., an electrically insulating substrate, it does not necessarily have to have a dielectric carrier element 9.2. The RFID transponder 9 can be arranged on the glass pane 4b directly or only separated by a thin carrier film and/or an adhesive film. It goes without saying that the RFID transponder 9 can also have a dielectric carrier element 9.2 in this exemplary embodiment, without affecting the mode of operation.

The dipole antenna 9.1 of the RFID transponder 9 is arranged in this example according to the invention with respect to the coupling element 10 and is thus electromagnetically coupled in its overhang region 10.1 with the coupling element 10. It goes without saying that in this exemplary embodiment, the coupling element 10 does not have to extend over the full end face 14 of the insulating glazing unit 1. It is sufficient, for example, for it to extend over the end face 14 of the second glass pane 4b and to be secured thereon. It further goes without saying that the coupling element 10 can also extend over the full end face 14 of the insulating glazing unit 1 and can extend beyond with a further overhang 10.1′ (analogous to FIG. 3A below).

The distance of the dipole antenna 9.1 of the RFID transponder 9 from the lower edge of the second glass pane 4b, i.e., to the edge where the end face 14 and the outer surface 18 of the second glass pane 4b adjoin, is, for example, 3 mm.

FIG. 1F depicts a detailed view (cross-sectional representation) of an edge region of an insulating glazing unit 1 in accordance with another embodiment of the invention. The insulating glazing unit 1 of FIG. 1F differs from the insulating glazing unit 1 of FIG. 1E only in the position of the RFID transponder 9, which, here, is arranged on the outer surface 18 of the first glass pane 4a. Furthermore, the coupling element 10 projects in a region 10′ on the side of the insulating glazing unit 1 facing away from the overhang 10.1 and thus beyond the end face 14 of the first glass pane 4a, in order to couple there to the dipole antenna 9.1 of the RFID transponder.

FIG. 1G depicts a detailed view (cross-sectional representation) of an edge region of an insulating glazing unit 1 in accordance with another embodiment of the invention. The insulating glazing unit 1 of FIG. 1A [sic: FIG. 1G] differs from the insulating glazing unit 1 of FIG. 1A only in the position of the RFID transponder 9, which, here, is arranged on the end face 14 of the first glass pane 4a. Since, here, the RFID transponder 9 is arranged on a glass pane, i.e., an electrically insulating substrate, it does not necessarily have to have a dielectric carrier element 9.2. The RFID transponder 9 can be arranged on the glass pane 4a directly or only separated by a thin carrier film and/or an adhesive film.

For galvanic isolation, a thin plastic film is arranged between dipole antenna 9.1 and coupling element 10, for example. It goes without saying that the galvanic isolation also [sic] by multiple plastic films that are arranged on the dipole antenna 9.1 and/or the coupling element 10 and are, for example, fixedly connected thereto.

FIG. 2A depicts a detailed view (cross-sectional representation) of an edge region of a glazing 2 with an insulating glazing unit 1 in accordance with FIGS. 1A and 1B.

FIG. 2B depicts a detailed view (plan view) of a detail of the glazing 2 with an insulating glazing unit 1 of FIG. 2A with a viewing direction in accordance with arrow A of FIG. 2A.

FIG. 2C depicts a detailed view (cross-sectional representation) of the glazing 2 in a section plane parallel to the end face 14 of the insulating glazing unit 1 of FIG. 2A with a viewing direction along the arrow B of FIG. 2A.

FIG. 2A-C depict detailed views of the insulating glazing unit 1 of FIGS. 1A and 1B as they can, for example, be arranged within a glazing 2. For details concerning the insulating glazing unit 1, reference is therefore made to the description of FIGS. 1A and 1B. It goes without saying that the insulating glazing units 1 of FIG. 10 or 1D or other exemplary embodiments according to the invention can also be arranged in the glazing 2.

Furthermore, a, for example, U-shaped frame 3 surrounds the edges of the insulating glazing unit 1 together with the RFID transponder 9 and the coupling element 10. In this example, the frame 3 comprises a first metal frame element 3.1 that is connected to a second metal frame element 3.2 via a polymeric and electrically insulating third frame element 3.3. In this example, the first and second frame elements 3.1, 3.2 are L-shaped. The frame 3, in the shape of a U, thus engages around the end face 14 of the insulating glazing unit 1. The sections of the first and second frame elements running parallel to the large surfaces of the glass panes 4a, 4b are implemented such that they completely cover at least the outer region 13 with the sealing element 6 and the spacerframe 5′ in the through-vision direction (arrow A) through the insulating glazing unit 1.

The insulating glazing unit 1 is arranged on supports (not shown here), in particular on plastic supports or support elements electrically insulated by plastics. Furthermore, arranged in each case between the metal frame elements 3.1, 3.2 and the glass panes 4a, 4b is an elastomer profile 7 such that the insulating glazing unit 1 is firmly held within the frame 3. The elastomer profile 7 has, for example, a thickness of 6.5 mm and fixes the distance between the respective frame elements 3.1, 3.2 and the glass panes 4a, 4b.

As shown in FIG. 2C, the dipole antenna 9.1 consists of a first antenna pole 9.1.1 and a second antenna pole 9.1.2, both of which are connected to electronics in the center of the RFID transponder 9. The coupling element 10 is arranged such that it completely covers the first antenna pole 9.1.1 and projects beyond the first antenna pole 9.1.1 on the side facing away from the second antenna pole 9.1.2. A capacitive coupling occurs as a result of this covering and the small distance between the first antenna pole 9.1.1 and the coupling element 10.

As shown in detail in FIGS. 2A and 2C, the coupling element 10 is coupled to the metal second frame 3.2 in a coupling region 15. For this purpose, the copper foil of the coupling element 10 rests, for example, over its entire length, against the second frame element 3.2 and and is galvanically connected thereto. It goes without saying that a capacitive coupling is also sufficient for coupling high-frequency signals in the operating range of the RFID transponder 9.

As investigations by the inventors surprisingly revealed, by coupling the coupling element 10 to the frame 3 of the glazing 2, the signal of the dipole antenna 9.1 of the RFID transponder 9 can be conducted to the outside; and, conversely, a signal can be supplied to the RFID transponder 9 from the outside. Surprisingly, the range of the RFID signal is significantly increased compared to glazings 2 with insulating glazing units 1 without coupling element 10.

Thus, with an RFID readout device, it was possible to read out signals at a distance of up to 2.5 m and to send signals to the RFID transponder 9—in particular on the side of the insulating glazing unit 1 on which the second, coupled, metal frame element 3.2 is arranged.

FIG. 3A depicts a detailed view (cross-sectional representation) of an edge region of a glazing 2 with an insulating glazing unit 1 in accordance with another embodiment of the invention,

FIG. 3B depicts a detailed view (cross-sectional representation) of the glazing in a section plane parallel to the end face 14 of the insulating glazing unit of FIG. 3A in the viewing direction of the arrow B of FIG. 3A.

FIGS. 3A and 3B depict a modified design that has largely the elements and the structure of the glazing 2 with an insulating glazing unit 1 of FIG. 2A-C. To that extent, the same reference numbers are used as there and the structure is not described again here.

The insulating glazing unit 1 of FIGS. 3A and 3B differs from FIGS. 2A and 2C in the design of the coupling element 10, which has here, on both sides, an overhang 10.1, 10.1′ beyond the second glass pane 4b and the first glass pane 4a. This yields two coupling regions 15, 15′, in which the coupling element 10 couples to the first and second frame elements 3.1, 3.2. Overall, this leads to a symmetrization of the above-described properties for improving readout ranges of the RFID signal such that equal signal strengths can be achieved on both sides of the insulating glazing unit 1.

Table 1 shows measurement results on a glazing 2 according to the invention with an insulating glazing unit 1 in accordance with FIGS. 3A and 3B and an insulating glazing unit 1 according to the invention in accordance with FIGS. 1A and 1B compared to a comparative example. The Comparative Example is a glazing unit not according to the invention having an insulating glazing unit with an RFID transponder 9 in accordance with FIG. 2A-C, but without a coupling element 10 according to the invention.

TABLE 1

| | Typical maximum reading range |
|---|---|
| | with RFID handheld reader |
| Comparative Example (glazing | 0.3 m-0.5 m |
| with RFID transponder without | |
| coupling element) | |
| Glazing with an insulating glazing | 1.5 m-2 m |
| unit of FIGS. 3A and 3B | |
| Insulating glazing unit of FIGS. 1A | 2 m-2.5 m |
| and 1B (without frame) | |

For the comparative measurements, the RFID transponder 9 was read out with a handheld RFID reader and the reader was arranged at increasing distance from the RFID transponder 9. The distance was measured with a laser rangefinder. The maximum reading range was independent of the side on which measurements were made relative to the insulating glazing.

In the Comparative Example of an RFID transponder 9, which was arranged in a glazing in the outer region 13 of a prior art insulating glazing unit (without a coupling element), a maximum reading range of 0.5 m resulted. The range of 0.3 m to 0.5 m reported in Table 1 was obtained from different angles at which the reader was held relative to the insulating glazing unit. Such a short range is insufficient for practical use, since in the case of an unknown position of the RFID transponder in the glazing, the entire frame must be searched.

In contrast, in the case of an insulating glazing unit 1 according to the invention with a coupling element 10 that is arranged in the frame 3 of a glazing 2 according to the invention, there were surprisingly ranges of up to 2 m. This is completely sufficient for practical use and corresponds to roughly half the distance values that an RFID transponder 9 has according to specification. For a freestanding insulating glazing unit 1 per FIGS. 1A and 1B (i.e., without the shielding frame 3 of a glazing), there was a maximum reading range of approx. 4 m.

FIG. 4 depicts a detailed view (cross-sectional representation) of a glazing 2 in a section plane parallel to the end face 14 of an insulating glazing unit 1 in accordance with another embodiment of the invention.

Here, one edge 16 of the coupling element 10 is not arranged centrally relative to the dipole antenna 9.1 (center of the dipole 17), but is shifted by an offset V of roughly 10 mm. The coupling element 10 thus also covers part of the second antenna pole 9.1.2. Nevertheless, good RFID signals were measured here. Overall, up to an offset V of 20% of the half wavelength lambda/2 of the operating frequency of the RFID transponder 9, good and practically utilizable signals or sufficiently large maximum reading ranges can be obtained. It is irrelevant whether the offset V is in the direction of the first antenna pole 9.1.1 or in the direction of the second antenna pole 9.1.2. Investigations by the inventors revealed that such an arrangement also positively affects the reception/transmission characteristics and increases the achievable readout distance of the RFID transponder 9.

The implementation of the invention is not restricted to the above-described examples and highlighted aspects of the embodiments, but is also possible in a large number of modifications that are evident to the person skilled in the art from the dependent claims.

### LIST OF REFERENCE CHARACTERS

1 insulating glazing unit
2 glazing
3 frame
3.1,3.2 metal, first or second frame element
3.3 polymeric, third frame element
4a, 4b glass panes
5 spacer
5′ spacer frame
5.1,5.2 pane contact surface
5.3 outer surface of the spacer 5
5.4 inner surface of the spacer 5
6 sealing element
7 elastomer profile
9 RFID transponder
9.1 dipole antenna
9.1.1, 9.1.2 first or second antenna pole
9.2 dielectric carrier element
10 coupling element
10′ region of the coupling element 10
10.1, 10.1′ overhang
12 inner region
13 outer region
13.1 outer side of the outer region 13
14 end face of the insulating glazing unit 1 or of the glass panes 4a, 4b
15 coupling region
16 edge of the coupling element 10
17 center of the dipole antenna 9.1
18 outer surface of the glass pane 4a or 4b
19 inner surface of the glass pane 4a or 4b
Arrow A plan view direction or through-vision direction
Arrow B plan view direction
A distance
L length
Lambda wavelength
U overhang
V offset

1. An insulating glazing unit, comprising:
at least one spacer which is shaped around a periphery to form a spacer frame and delimits an inner region,
a first glass pane, which is arranged on a pane contact surface of the spacer frame, and a second glass pane, which is arranged on a second pane contact surface of the spacer frame, and
the first and second glass panes project beyond the spacer frame, and an outer region is formed, which is filled, at least in sections with a sealing element,
wherein
at least one RFID transponder is arranged in the outer region or in an outer edge region of the first and second glass panes,
a strip-shaped coupling element is electromagnetically coupled to the at least one RFID transponder, and
the strip-shaped coupling element projects in sections beyond an end face of the insulating glazing unit along the first glass pane and/or along the second glass pane.

2. The insulating glazing unit according to claim 1, wherein the strip-shaped coupling element contains or is made of a metallized polymer film or a self-supporting metal foil.

3. The insulating glazing unit according to claim 2, wherein the metallization of the polymer film has a thickness of 10 μm to 200 μm and the metal foil has a thickness of 0.02 mm to 0.5 mm.

4. The insulating glazing unit according to claim 1, wherein the strip-shaped coupling element projects in sections beyond the end face of the insulating glazing unit along the first glass pane by an overhang U of 2 mm to 30 mm.

5. The insulating glazing unit according to claim 1, wherein the at least one RFID transponder is arranged in the outer region and directly on an outer surface of the spacer or on one of inner surfaces of the first and second glass panes or in a middle of the outer region.

6. The insulating glazing unit according to claim 1, wherein the at least one RFID transponder is arranged on an outer surface of one of the first and second glass panes at a distance of at most 10 mm from an adjacent end face of the respective glass pane and/or wherein the at least one RFID transponder is arranged on an end face of one of the first and second glass panes.

7. The insulating glazing unit according to claim 1, wherein the strip-shaped coupling element is arranged
within the sealing element in the outer region,
on an outer side of the outer region,
on at least one end face of the first and second glass panes, and/or
on an outer side of the first and second glass panes.

8. The insulating glazing unit according to claim 1, wherein a distance A between a dipole antenna of the at least one RFID transponder and the strip-shaped coupling element is from 0 mm to 10 mm.

9. The insulating glazing unit according to claim 1, wherein the strip-shaped coupling element is arranged in sections congruently over the at least one RFID transponder.

10. The insulating glazing unit according to claim 1, wherein the at least one RFID transponder includes or consists of a dipole antenna with a first antenna pole and a second antenna pole.

11. The insulating glazing unit according to claim 10, wherein the strip-shaped coupling element covers exactly one of the first and second antenna poles and projects beyond the one of the first and second antenna poles on the side facing away from the other one of the first and second antenna poles.

12. The insulating glazing unit according to claim 10, wherein one edge of the strip-shaped coupling element has, in the projection, an offset V from a center of the dipole antenna of −20% to +20% of a half wavelength lambda/2 of an operating frequency of the at least one RFID transponder.

13. The insulating glazing unit according to claim 10, wherein one edge of the strip-shaped coupling element has, in the projection, an offset V from a center of the dipole antenna at an operating frequency of the at least one RFID transponder in the UHF range of −30 mm to +30 mm.

14. The insulating glazing unit according to claim 1, wherein the strip-shaped coupling element has a length L parallel to a direction of extension of the dipole antenna greater than or equal to 40% of a half wavelength lambda/2 of an operating frequency of the dipole antenna.

15. The insulating glazing unit according to claim 1, wherein the strip-shaped coupling element has a length L parallel to a direction of extension of the dipole antenna greater than or equal to 7 cm.

16. A glazing, comprising:
a frame consisting of a metal first frame element, a metal second frame element, and a polymeric third frame element connecting the metal first and second frame elements at least in sections, and
an insulating glazing unit according to claim 1 arranged in the frame,
wherein the strip-shaped coupling element is galvanically or capacitively coupled in at least one coupling region with one of the metal first and second frame elements.

17. The glazing according to claim 16, wherein the metal engages around the end faces of the insulating glazing unit and, at the same time, covers the at least one RFID transponder(s) in a through-vision direction through the first and second glass panes.

18. A method comprising identifying a glazing according to claim 16 with the at least one RFID transponder.

19. The insulating glazing unit according to claim 1, wherein the outer region is filled completely with the sealing element.

20. The insulating glazing unit according to claim 2, wherein the strip-shaped coupling element is made of aluminum, an aluminum alloy, copper, silver, or stainless steel.
